(19) United States
(12) Patent Application Publication
(10) Pub. No.: US 2026/0316231 A1
(43) Pub. Date: Oct. 15, 2026

(54) Hand-Held Power Tool comprising a Mechanical Rotary Percussion Mechanism

(71) Applicant: Robert Bosch GmbH, Stuttgart (DE)

(72) Inventors: Tobias Herr, Grafenau (DE); Jens Blum, Filderstadt (DE)

(21) Appl. No.: 19/108,568

(22) PCT Filed: Aug. 4, 2023
(86) PCT No.: PCT/EP2023/071688

§ 371 Date: Mar. 4, 2025

(30) Foreign Application Priority Data
Sep. 7, 2022 (DE) 10 2022 209 286.4

(51) Int. Cl. B25B 21/02; B25F 5/00

(52) U.S. Cl. CPC B25B 21/02; B25F 5/001; B25F 5/006

(57) ABSTRACT

A hand-held power tool has a tool holder and a housing, in which a drive motor and a gear box are disposed. The gear box is associated with a mechanical rotary striking mechanism for percussively driving a tool holder. The tool holder is associated with a receiving sleeve. The gear box and the mechanical rotary striking mechanism are disposed in a gear housing. The mechanical rotary striking mechanism has an impact body and an anvil associated with the receiving sleeve. The receiving sleeve is supported radially within a bearing element fixed in the gear box in a rotatable and axially slidable manner. A buffer ring is provided which faces the impact body in the gear box and is at least partially axially disposed between the anvil and the bearing element. The buffer ring has an inner diameter that is smaller than an outer diameter of the bearing element.

### PRIOR ART

The present invention relates to a hand-held power tool having a tool holder and a housing, in which a drive motor and a gear box are disposed, wherein the gear box is associated with a mechanical rotary striking mechanism for percussively driving a tool holder, wherein the tool holder is associated with a receiving sleeve, wherein the gear box and the mechanical rotary striking mechanism are disposed in a gear box housing, wherein the mechanical rotary striking mechanism has an impact body and an anvil associated with the receiving sleeve, and wherein the receiving sleeve is radially supported within a bearing element fixed in the gear box in a rotatable and axially displaceable manner.

Such a hand-held power tool configured as an impact driver with a mechanical rotary striking mechanism is known from the prior art. The mechanical rotary striking mechanism comprises a spring-mounted impact body and an anvil. During percussive driving of the mechanical rotary striking mechanism, in which the impact body strikes the anvil axially, undesirable vibrations and force impacts are created on the gear box housing in addition to desired force impacts.

### DISCLOSURE OF THE INVENTION

The invention relates to a hand-held power tool having a tool holder and a housing, in which a drive motor and a gear box are disposed, wherein the gear box is associated with a mechanical rotary striking mechanism for percussively driving a tool holder, wherein the tool holder is associated with a receiving sleeve, wherein the gear box and the mechanical rotary striking mechanism are disposed in a gear box housing, wherein the mechanical rotary striking mechanism has an impact body and an anvil associated with the receiving sleeve, and wherein the receiving sleeve is radially supported within a bearing element fixed in the gear box in a rotatable and axially displaceable manner. A buffer ring is provided that faces the impact body in the gear box and is disposed at least in regions axially between the anvil and the bearing element, wherein the buffer ring has an inner diameter that is smaller than an outer diameter of the bearing element.

The invention thus enables the provision of a hand-held power tool with a mechanical rotary impact mechanism in which undesirable vibrations and force impacts that are created when the mechanical rotary striking mechanism strikes, upon which the impact body axially impacts the anvil, are dampened by the buffer ring. Thus, damage or destruction of the gear box as a result of the undesired vibrations and impacts can be effectively prevented.

Preferably, an outer diameter of the buffer ring is greater than an outer diameter of the bearing element.

Thus, an arrangement of the buffer ring radially outside of the bearing element can be easily and straightforwardly enabled.

The inner diameter of the buffer ring is preferably greater than an inner diameter of the bearing element.

Thus, axial support of the bearing element by the buffer ring can be facilitated in a simple manner.

According to one embodiment, the buffer ring has an anti-rotation element on its outer circumference for forming an anti-rotation feature.

Thus, a safe and reliable anti-rotation feature of the buffer ring can be provided.

Preferably, the anti-rotation element comprises at least one, preferably radially aligned anti-rotation bar.

Thus the anti-rotation feature can be configured in a simple way.

Preferably, the gear box housing comprises a receiving element corresponding to the anti-rotation element.

Thus, a positive locking mechanism can be easily and straightforwardly configured as an anti-rotation feature.

According to one embodiment, the buffer ring comprises at least one recess between its outer diameter and its inner diameter.

Thus, an alternative anti-rotation feature may be provided in a simple manner.

Preferably, the gear box has at least one elevation on its inner side facing the tool holder for arrangement in the at least one recess of the buffer ring.

The alternative anti-rotation feature can thus be easily and straightforwardly configured.

According to one embodiment, at least two bearing elements are provided that are in axial contact along an axis of rotation of the tool holder.

This enables a compact arrangement of the at least two bearing elements.

Preferably, the buffer ring comprises steel sheet and/or plastic.

Thus, a straightforward and inexpensive buffer ring may be provided.

### BRIEF DESCRIPTION OF THE DRAWINGS

The invention is explained in more detail in the following description with reference to the exemplary embodiments shown in the drawings. The figures show:

FIG. 1 a schematic view of a hand-held power tool having a mechanical rotary striking mechanism,

FIG. 2 a longitudinal cross-section through the mechanical rotary striking mechanism of FIG. 1 with a buffer ring disposed in a gear box,

FIG. 3 a top perspective view of the buffer ring of FIG. 2 disposed in the gear box,

FIG. 4 a perspective view of the buffer ring of FIG. 2 and FIG. 3,

FIG. 5 a front view of the gear box housing of FIG. 1 to FIG. 3, and

FIG. 6 a longitudinal section through the gear box of FIG. 1 to FIG. 3 and FIG. 6.

### DESCRIPTION OF THE EXEMPLARY EMBODIMENTS

Elements having the same or a comparable function are provided with the same reference signs in the figures and are described in detail only once.

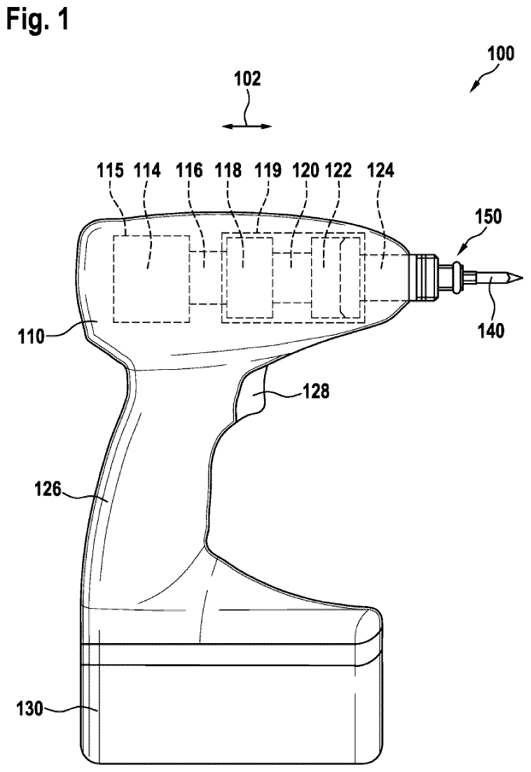

FIG. 1 shows a hand-held power tool 100 with a tool holder 150 which has a housing 110 having a handle 126. According to the embodiment shown, the hand-held power tool 100 is mechanically and electrically connectable to a battery pack 130 for electricity supply apart from an electrical network.

Illustratively, an electric drive motor 114 supplied with electricity by the battery pack 130, a gear box 118 and a mechanical striking mechanism 122 are arranged within the housing 110. The drive motor 114 is, e.g., operable (i.e., can be switched on and off) via a hand switch 128, and can be any desired type of motor, e.g., an electronically commutated motor or a DC motor. Preferably, the drive motor 114 can be controlled or regulated electronically in such a way that both a reversing operation and specifications with regard to a desired rotational speed can be realized. The functionality and construction of a suitable drive motor are sufficiently known from the prior art, so a detailed description is omitted herein for the purpose of brevity in the description.

The drive motor 114 is preferably connected to the gear box 118 via an associated motor shaft 116 such that rotation of the motor shaft 116 is converted into rotation of an intermediate shaft 120 provided between the gear box 118 and the striking mechanism 122. Preferably, this conversion takes place such that the intermediate shaft 120 rotates relative to the motor shaft 116 with increased torque, but at a reduced rotational speed. The drive motor 114 is illustratively arranged within an engine housing 115. The mechanically rotary striking mechanism 122 and/or gear box 118 are disposed within a gear box 119 by way of example. The gear box housing 119 and the engine housing 115 are illustratively disposed inside the housing 110. Alternatively, the mechanical rotary striking mechanism 122 can also be disposed in a separate striking mechanism housing.

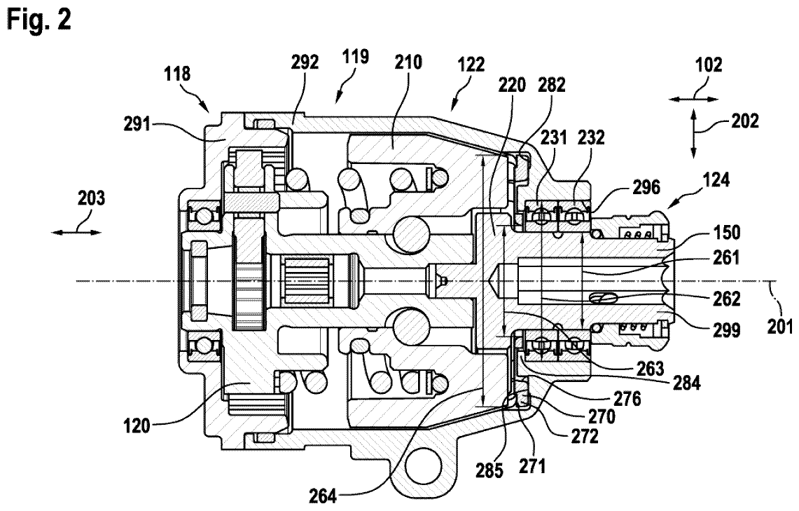

The mechanical striking mechanism 122 connected to the intermediate shaft 120 is, for example, a rotary or oscillating-rotary striking mechanism that generates high-intensity oscillatory rotary impulses and transmits them to an output shaft 124, e.g., an output spindle. In the following, the mechanical striking mechanism is referred to as “mechanical rotary striking mechanism 122”. In particular, the mechanical rotary striking mechanism 122 is provided for percussively driving the tool holder 150 and associated with it. The mechanical rotary striking mechanism 122 illustratively comprises a spring-loaded impact body (210 in FIG. 2) that is coupled to the intermediate shaft 120 and is mounted on the intermediate shaft 120 so that it can slide on it in the axial direction 102 of the gear box 118.

Provided on the output shaft 124 is the tool holder 150, which is preferably designed to receive insert tools and is connectable according to one embodiment to an insert tool 140 having an outward multi-face coupling. The insert tool 140 is, e.g., designed as a screwdriver bit having an outward multi-face coupling, illustratively an octagonal coupling. Such a screwdriver bit is sufficiently known from the prior art, so a detailed description is omitted herein for the purpose of brevity in the description.

FIG. 2 shows the gear mechanism 118 arranged in the gear housing 119 of FIG. 1, as well as the mechanical rotary striking mechanism 122 with the intermediate shaft 120 of FIG. 1. FIG. 2 shows the mechanical rotary striking mechanism 122, which preferably has a spring-loaded impact body 210 and an anvil 220 that can be impacted by the impact body 210. The anvil 220 is preferably associated with the tool holder 150, in particular with a receiving sleeve 299 associated with the tool holder 150. Preferably, the anvil 220 is formed in one piece with the receiving sleeve 299. In this case, the anvil 220 is embodied transversely illustratively, in particular substantially perpendicular to the receiving sleeve 299.

The mechanical rotary striking mechanism 122 generates sudden high-intensity rotary impulses and transfers them to the output shaft 124 and, via the anvil 220, to the receiving sleeve 299 of the tool holder 150. The spring-loaded impact body 210 is slidably supported in the axial direction 102 of the gear box 118. A mechanical rotary striking mechanism 122 of this kind is sufficiently known from the prior art, so a detailed description is omitted herein for the purpose of brevity in the description.

Preferably, the insert tool 140 of FIG. 1 can be disposed in the receiving sleeve 299. The receiving sleeve 299 is preferably radially mounted within a bearing element 231, 232 fastened in the gear box housing 119, such that it can rotate and slide axially. Illustratively, the gear box housing 118 comprises two sections 291, 292, which are connected to one another. The section 291 is preferably configured as a lid that is attached to the section 292.

According to the present invention, a buffer ring 270 is provided which is preferably disposed in the gear box 119 and configured to dampen impact energy transferred by the impact body 210 to the gear box 119. The buffer ring 270 faces the impact body 210 and is preferably arranged at least in some regions axially between the anvil 220 and the bearing element 231, 232. The at least one bearing element 231, 232 is disposed in a receptacle 296 of the gear box housing 119, or the section 292 of the gearbox housing 119, respectively. Here, the at least one bearing element 231, 232 is disposed radially between the gear box 118 and the receiving sleeve 299. Two bearing elements 231, 232 are arranged in the receptacle 296 of the gear housing 119. The two illustrative bearing elements 231, 232 are in axial contact along the axis of rotation 201 of the tool holder 150, i.e., they are in contact with each other. According to one embodiment, the bearing elements 231, 232 are designed as rolling bearings, in particular ball bearings.

The tool holder 150 illustratively comprises an axial longitudinal extension 203. It is noted that, in the context of the present invention, the term “axial” is understood to mean a direction along the longitudinal extension 203 of the tool holder 150. Furthermore, the term “radial” is understood to mean a direction approximately perpendicular to the longitudinal extension 203 of the tool holder 150. The radial direction 202 is therefore oriented approximately perpendicular to the axial direction 102 of the gear box 118, or respectively along the longitudinal extension 203 of the tool holder 150. Furthermore, the axial direction 102 is substantially parallel to the longitudinal extension 203 of the tool holder 150 or parallel to an axis of rotation 201 of the tool holder 150.

The buffer ring 270 preferably comprises an inner diameter 263 facing the receiving sleeve 299 and an outer diameter 264 facing away from the receiving sleeve 299. The inner diameter 263 is preferably less than an outer diameter 262 of the bearing element 231, 232. Furthermore, the outer diameter 264 of the buffer ring 270 is preferably greater than an outer diameter 262 of the bearing element 231, 232. In addition, the inner diameter 263 of the buffer ring 270 is preferably greater than or equal to an inner diameter 261 of the bearing element 231, 232. Thus, the buffer ring 270 can axially support the bearing element 231 on its inner diameter 263.

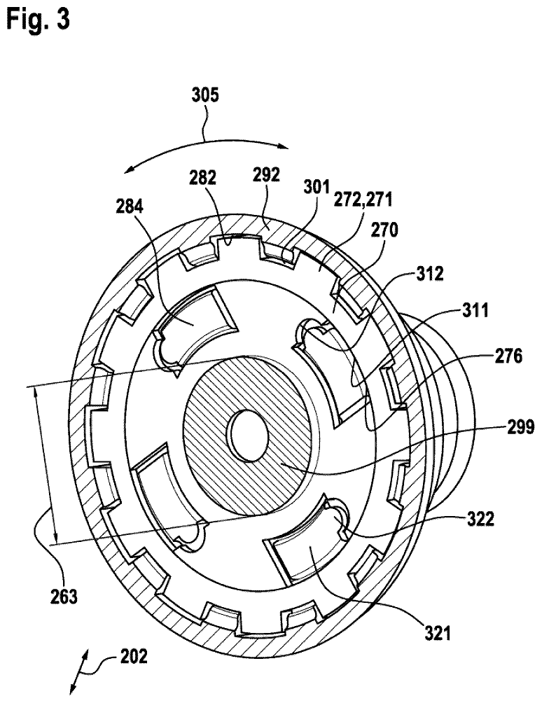

According to one embodiment, on its outer perimeter (301 in FIG. 3), the buffer ring 270 comprises an anti-rotation element 272 for forming an anti-rotation feature with the gear box 119. The anti-rotation element 272 preferably comprises at least one, preferably radially aligned anti-rotation bar 271. Preferably, the gear box housing 119 comprises a receiving element 282 corresponding to the anti-rotation element 272. Preferably, the receiving element 282 is configured as a receptacle.

Alternatively or optionally, the buffer ring 270 comprises at least one recess 276 between its outer diameter 264 and its inner diameter 263. Analogously, the gear box 119 preferably has at least one elevation 284 on its section 292 on its inner side 285 facing the tool holder 150 for arrangement in the at least one recess 276 of the buffer ring 270. Preferably, the buffer ring 270 comprises steel sheet and/or plastic.

FIG. 3 shows the buffer ring 270 of FIG. 2 disposed in the section 292 of the gear box housing 119 of FIG. 2. FIG. 2 illustrates the buffer ring 270 with the anti-rotation element 272 disposed on the outer circumference 301. As described above, the anti-rotation element 272 comprises at least one, preferably radially aligned anti-rotation bar 271.

Illustratively, twelve anti-rotation bars 271 are arranged in the circumferential direction 305 of the buffer ring 270. However, any number of anti-rotation bars 271 may be provided. The anti-rotation bars 271 are preferably configured as rectangular. It is noted that the anti-rotation bars 271 can have any shape, e.g., a triangular, polygonal or semi-circular shape. Illustratively, the anti-rotation bars 271 have the same radial height in the radial direction 202, but the anti-rotation bars 271 can also have different radial heights in the circumferential direction 305. Preferably, all anti-rotation bars 271 are of the same shape, but the anti-rotation bas 271 may also be of different shapes in the circumferential direction 305.

Furthermore, FIG. 3 shows the receiving element 282 corresponding to the anti-rotation element 272 in section 292 of the gear box 119 for forming an anti-rotation feature between the buffer ring 270 and the gearbox 119. Moreover, FIG. 3 shows the at least one recess 276 disposed between the outer diameter 264 and the inner diameter 263 of the buffer ring 270. Illustratively, four recesses 276 are disposed in the circumferential direction 305 of the buffer ring 270, however, the buffer ring 270 may have any number of recesses 276. Each recess 276 has, by way of example, an arcuate section 311 with an illustrative lateral semi-circular section 312. Accordingly, the section 292 or the one elevation 284 comprises an arcuate section 321 with an illustrative lateral semi-circular section 322. Analogously to the anti-rotation element 272, the recess 276 can have any shape. For example, the recess 276 may be rectangular, polygonal, oval, or round. Moreover, differently formed recesses 276 may also be formed in the circumferential direction 305 of the buffer ring 270.

Furthermore, the anti-rotation bars 271 and the recesses 276 are diametrically opposite one another, but may also be arranged at irregular intervals in the circumferential direction 305. Moreover, the anti-rotation bars 271 may be diametrically opposed to one another and the recesses 276 may be disposed at irregular intervals in the circumferential direction 305, or vice versa. Illustratively, the recesses 276 are disposed in the radial direction 202 between the anti-rotation bars 271 and the inner diameter 263 of the buffer ring 270. However, the recesses 276 may also be disposed in the circumferential direction 305 offset from the anti-rotation bars 271.

It is noted that the buffer ring 270 may have the anti-rotation element 272 and/or the at least one recess 276. Thus, the buffer ring 270 may only be formed with the anti-rotation bars 271 or with the recesses 276.

According to another embodiment, the section 292 of the gear box 119 may have the anti-rotation element 272 and/or the at least one recess 276, and the buffer ring 270 may have the receiving element 282 corresponding with the anti-rotation element 272 and/or the elevation 284 associated with the recess 276.

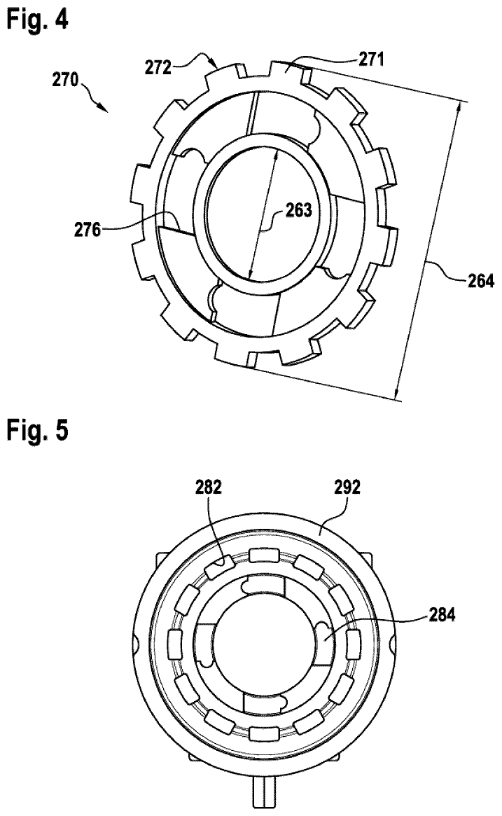

FIG. 4 shows the buffer ring 270 of FIG. 2 and FIG. 3 with the anti-rotation element 272 and the recesses 276 for forming an anti-rotation feature with the gear box 119 of FIG. 1 to FIG. 3. Furthermore, FIG. 4 illustrates the outer diameter 264 and the inner diameter 263 of the buffer ring 270.

FIG. 5 shows the section 292 of the gear box housing 119 of FIG. 1 to FIG. 3. FIG. 5 illustrates the receiving element 282 for receiving the anti-rotation element 272 of the buffer ring 270 of FIG. 2 to FIG. 4, as well as the elevations 284 associated with the recess 276 of the buffer ring 270. In FIG. 5, only one of the illustrative four elevations 284 is labeled with a reference numeral for simplicity and clarity.

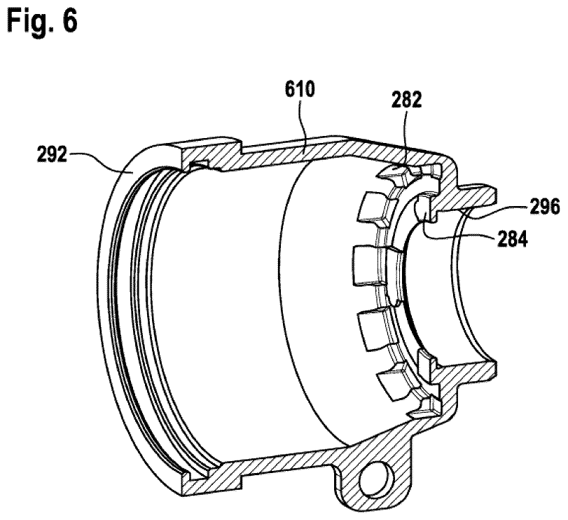

FIG. 6 shows the section 292 of the gear box housing 119 of FIG. 5 with a pot-shaped base body 610 and the receiving element 282 disposed axially facing the tool holder 150 of FIG. 2 and the elevations 284, as well as the receptacle 296 for arranging at least one bearing element 231, 232. Preferably, the elevations 284 form an axial support for the at least one bearing element 231, 232 that can be disposed in the receptacle 296, thereby preventing the at least one bearing element 231, 232 from sliding in the axial direction 102 of the gear box 118 towards the drive motor 114 or, illustratively, to the left. To this end, the elevation 284 closes the receptacle 296 in sections at its radially outer region.

1. A hand-held power tool, comprising:
a tool holder;
a drive motor;
a gear box;
a housing, in which the drive motor and the gear box are disposed;
a buffer ring; and
a mechanical rotary striking mechanism associated with the gear box, and configured to percussively drive the tool holder,
wherein the tool holder is associated with a receiving sleeve,
wherein the gear box and the mechanical rotary striking mechanism are disposed in a gear box housing,
wherein the mechanical rotary striking mechanism has an impact body and an anvil associated with the receiving sleeve,
wherein the receiving sleeve is radially supported within a bearing element fixed in the gear box in a rotatable and axially slidable manner,
wherein the buffer ring faces the impact body in the gear box and is at least partially axially disposed between the anvil and the bearing element, and
wherein the buffer ring has an inner diameter that is smaller than an outer diameter of the bearing element.

2. The hand-held power tool according to claim 1, wherein an outer diameter of the buffer ring is greater than an outer diameter of the bearing element.

3. The hand-held power tool according to claim 1, wherein the inner diameter of the buffer ring is greater than an inner diameter of the bearing element.

4. The hand-held power tool according to claim 1, wherein the buffer ring has an anti-rotation element on its outer circumference which is configured to form an anti-rotation feature.

5. The hand-held power tool according to claim 4, wherein the anti-rotation element has at least one, radially aligned anti-rotation bar.

6. The hand-held power tool according to claim 4, wherein the gear box has a receiving element corresponding to the anti-rotation element.

7. The hand-held power tool according to claim 1, wherein the buffer ring has at least one recess between its outer diameter and its inner diameter.

8. The hand-held power tool according to claim 7, wherein the gear box has at least one elevation on its inner side facing the tool holder which is configured to be arranged in the at least one recess of the buffer ring.

9. The hand-held power tool according to claim 1, further comprising at least two bearing elements that are arranged in axial contact along an axis of rotation of the tool holder.

10. The hand-held power tool according to claim 1, wherein the buffer ring comprises steel sheet and/or plastic.
